(19) United States
(12) Patent Application Publication
(10) Pub. No.: US 2010/0179081 A1
(43) Pub. Date: Jul. 15, 2010

(54) COMPOSITION TO BE IMPREGNATED IN WIPES FOR CLEANING AND/OR POLISHING CONTAMINATED SURFACES

(75) Inventor: Erik Bernisson, Caussade (FR)

Correspondence Address: YOUNG & THOMPSON, 209 Madison Street, Suite 500, Alexandria, VA, 22314, US

(73) Assignee: DALTA, Montpezat du Quercy (FR)

(21) Appl. No.: 12/663,609

(22) PCT Filed: Jun. 6, 2008
(86) PCT No.: PCT/FR08/00774

§ 371 Date: Dec. 8, 2009

(30) Foreign Application Priority Data
Jun. 8, 2007 (FR) 07 04121

(51) Int. Cl. C11D 17/04; C11D 17/00

(52) U.S. Cl. 510/109; 510/438

(57) ABSTRACT

A wipe for cleaning and polishing contaminated surfaces, such the external bodywork of a car, includes a substrate impregnated with a cleaning and polishing composition that is not in an emulsion form, characterised in that the composition includes at least an agent for the suspension of organic and/or inorganic materials (a), at least one cleaning agent (b) and at least one shine agent (c) and optionally a preservative agent (d), the above constituents being distinct from each other and non miscible in order to form a multiphase composition at rest. A method for making a wipe containing the above-mentioned cleaning and/or polishing composition is described.

The present invention relates to a composition intended to be impregnated in wipes for cleaning and polishing contaminated surfaces, such as surfaces filthy with dust, mud, asphalt, corroded paint or any other materials.

The object of the invention is also a wipe comprising said cleaning and polishing composition.

An object of the present invention relates to a method for making said wipe.

In a known way, the cleaning of a contaminated surface requires several steps and the use of various products for each step. Indeed, it is necessary to use a detergent for the cleaning step, water for diluting the active ingredient of said detergent, water again for the rinsing step, chemicals of the sequestrant type or of another type in order to remove the residual traces of water generated during the drying step and a blower in order to activate said drying.

The polishing of a surface, such as the outer body of a car, represents an additional step to the cleaning step. Further, existing products do not allow easy polishing since the polishing compositions need to be vigorously spread manually or mechanically. These polishing compositions generally include one or more solvents and wax and appear as a cream, a paste, packaged as an aerosol or as bulk liquids.

Thus, there is no product on the market which allows both cleaning and polishing in a single application of a composition for wipes.

For this purpose, the invention relates to a wipe intended for cleaning and polishing contaminated surfaces, such as the outer body of a car, said wipe comprising a support impregnated with a cleaning and polishing composition which is not in the form of an emulsion, characterized in that said composition comprises at least one agent for suspending organic and/or inorganic materials (a), at least one cleaning agent (b) and at least one shine agent(c) and possibly a preservative agent (d), said aforementioned constituents being distinct from each other and non-miscible, so as to form a multiphase composition at rest.

Advantageously, the agent for suspending organic and/or inorganic materials (a) is selected from: an agent for suspending organic materials, such as an aqueous solvent like water, an alcoholic aqueous solution, an acid aqueous solution, a basic aqueous solution, a cationic surfactant, a non-ionic surfactant, an anionic surfactant, an amphoteric surfactant, an emulsifying agent or mixtures thereof.

Preferably, the cleaning agent (b) is selected from solvents with an KBI, a Kauri Butanol Index, comprised between 25 and 300, such as a chlorinated, oxygenated, aromatic organic solvent, a non-polar solvent such as dearomatized and non-dearomatized hydrocarbons, linear paraffins, cycloparaffins, isoparaffins, aromatics, deoxidizing agents or mixtures thereof.

Advantageously, the shine agent(c) is selected from mineral oils, synthetic oils or mixtures thereof.

Further, the composition according to the present invention may comprise preservative agents (d) of the fungicidal type or of the anti-oxidant type, so as to avoid putrefaction of said composition during its storage.

According to a characteristic of the invention, the composition comprises by weight, 1% to 80%, preferably 60% to 80% of said agent for suspending organic and/or mineral materials (a), 1% to 80%, preferably 10% to 30% of said cleaning agent (b), 0.1% to 60%, preferably from 0.1% to 40% of said shine agent(c) and optionally 0.01% to 80%, preferably from 0.01% to 10% of said preservative agent (d), based on the total weight of said composition.

Preferably, the cleaning composition during the storage of the wipe in the vertical position forms layers according to the density of the different constituents of said composition.

Preferentially, the wipe is a woven, no-woven, knitted material or a composite film, so as to be resistant during the cleaning and polishing step.

Advantageously, the impregnation rate of the unstable cleaning and polishing composition expressed as the mass of said composition per wipe unit mass is comprised between 0.1 g/g and 10 g/g.

Another object of the present invention relates to a method for making said wipe according to the invention, characterized in that the method comprises at least the steps of:
a) preparing a cleaning and polishing multiphase composition which does not appear as an emulsion according to one of the characteristics above,
b) continuously stirring said composition so as to obtain a temporarily homogeneous mixture,
c) impregnating up to a predetermined rate said wipe with the obtained homogeneous mixture, the impregnation being accomplished so as to distribute said composition homogeneously in said wipe so that each wipe contains the suitable dose of each of the constituents of said composition,
d) vertically conditioning said either impregnated wipe or not in a sealed package compatible with said composition, the steps c) and d) may be performed in any order.

The invention will be better understood and other objects, details, characteristics of the latter will become more clearly apparent during the detailed explanatory description which follows of an embodiment of the invention, given purely as an illustration and not as a limitation.

In many fields, such as that of metallurgy, the automobile industry, aeronautics or further that of the building industry, it is necessary to have a clean, properly cleaned and polished surface. These surfaces may be contaminated by elements as varied as: pollution, pollen, dust, insects, earth, corroded paint or further for example tar.

As indicated earlier, the present invention relates to a composition intended to be impregnated in at least one wipe in order to clean and polish said contaminated surfaces and this, in a single application and without adding any water.

Said composition impregnating the wipe is characterized in that, unlike the wipes comprising a surface treatment, said cleaning and polishing composition is said to be <<multiphase at rest>>.

According to the present invention, a composition which is <<multiphase at rest>> means that the different constituents of the cleaning and polishing composition are non-miscible when they are not mixed manually or mechanically and therefore form strata or layers in said wipe depending on their densities.

The applicant indeed discovered surprisingly that by using a cleaning and polishing composition which is <<multiphase at rest>> and therefore contrary to the practice usually used in the field of chemistry and more particularly in the field of surface treatment wipes, it was possible to achieve an effective and simple cleaning and polishing of the surface to be treated. The cleaning and polishing composition is further not in the form of an emulsion.

Said composition comprises at least three different agents: an agent for suspending organic and/or inorganic materials (a), at least one cleaning agent (b) and at least one shine agent(c).

The agent for suspending organic and/or inorganic materials (a) may be any types of aqueous solvents such as water, an alcohol aqueous solution, an acid aqueous solution, a basic aqueous solution and/or a surfactant.

The surfactant may be selected from the family of cationic, non-ionic, anionic or amphoteric surfactants.

The cationic surfactants may correspond to a quaternary alkylammonium halide, a dialkyldimethylammonium halide, a quaternary ammonium ester, a quaternary alkyl or dialkyl imidazoline, a quarternary dialkylamidoamine, a dialkylaminodazoline ester, a quaternary dihydroxypropylammonium dialkylester chloride, a quaternary triethanolammonium dialkylester methyl sulfate or mixtures thereof.

The non-ionic surfactants which are suitable for the present invention may be selected from ethoxylated fatty alcohols of general formula RO(CH₂CH₂O)ₙH wherein R is an alkyl, alkene, alkyne group, . . . and n is a positive natural integer, or mixtures thereof.

The ionic surfactants which are suitable for the present invention are for example alkylbenzenesulfonates (ABS), linear alkylsulfonates (LAS), secondary alkanesulfonates (SAS), fatty alcohol sulfates including polyalkylsulfates (PAS), sodium alphaolefin sulfonates (AOS), alkylethersulfates including laurylethersulfates (LES), sulfosuccinates, alkyl isethionates, methylethersulfates (mES), soaps, fatty acid sulfoalkylamides, diglycolamide sulfates, acylated N-aminoacids such as acyl sarcosinates, polyoxyethylene carboxylates or mixtures thereof.

The amphoteric surfactants which may be used as an agent for suspending organic and/or mineral materials may be betaine derivatives such as cocoamidobetaine, cocamidopropylbetaine, undecylaminopropylbetaine or mixtures thereof.

The agent for suspending organic materials has the function of carrying away in water the organic and/or inorganic materials, depending on the compounds used and known to one skilled in the art. These constituents actually allow removal of all deposits of the type: insects, pollution, pollens, earth, tars, faded, corroded paints, therefore removing the colorless aspect of the surface to be treated, contaminated by these elements.

The cleaning agent (b) suitable for the present invention may correspond to a solvent with a KBI, Kauri Butanol Index, comprised between 25 and 300, such as chlorinated, oxygenated, aromatic organic solvent, etc., a non-polar solvent such as dearomatized and non-dearomatized hydrocarbons, linear paraffins, cycloparaffins, isoparaffins, aromatics, deoxidizing agents or mixtures thereof.

The cleaning agent (b) associated with the wipe allows the dirt of the contaminated surface to be caught, extracted and retained.

The shine agents (c) may comprise mineral oils, synthetic oils, polyalkylglycols, polydimethylsiloxanes, polyalphaolefins, polyalkylperfluoroethers, silicones, oils of vegetable origin and their derivatives, oils of animal origin and their derivatives or mixtures thereof.

These shine agents (c) have the function of brightening the surface to be cleaned and polished.

Indeed they have the property of depositing a shiny, anti-dirt, anti-water and protective film on said surface treated with the present invention.

Further, the present cleaning and polishing composition for wipes comprises a preservative agent (d) such as fungicides or an anti-oxidant. The latter, as indicated above, avoid putrefaction during storage of said composition or of the wipes comprising said composition.

Given that the constituents of the composition are non-miscible, layers will form during the packaging of said composition. Thus, during the natural separation of the different constituents of said composition, the low density components will remain on the top, while the components of greater density will move towards the bottom of the wipe positioned vertically. This will have the advantage of strongly limiting the evaporation of the volatile solvents usually present in the wipes for treating surfaces, since the latter will be confined by an upper layer of lower density, such as an aqueous solution for example. Thus, no loss of effective agents during storage is observed with the wipes according to the present invention.

Generally, said composition comprises by weight, 1% to 80%, preferably 60% to 80% of said agent for suspending organic and/or mineral materials (a), 1% to 80%, preferably 10% to 30% of said cleaning agent (b), 0.1% to 60%, preferably from 0.1% to 40% of said shine agent(c) and possibly 0.01% to 80%, preferably from 0.01% to 10% of said preservative agent (d), based on the total weight of said composition.

More particularly, said composition may comprise by weight, 59% of an agent for suspending organic materials (a), i.e. an aqueous solvent like water, an alcoholic aqueous solution, an acid aqueous solution, a basic aqueous solution, 8% of a non-ionic surfactant (a), such as ethoxylated fatty acid, 9% of an anionic surfactant (a) such as an alkylbenzene-sulfonate, 0.5% of an emulsifying agent (a), for example Polysorbate 20, 10% of a degreasing agent (b) of the organic solvent type comprising an oxo function group, 10% of a non-polar solvent (b) such as an alkane hydrocarbon, 2% of a shine agent(c) such as a polyalkylglycol or polydimethylsiloxane, 0.80% of a fungicide (d) and 0.7% (d) of an anti-oxidizing agent, based on the total weight of said composition.

The present invention also relates to a wipe intended for cleaning and polishing contaminated surfaces which comprises a support impregnated with the non-miscible composition as described above which forms in said wipe, layers during the storage of the wipe in a vertical position.

As said wipe is intended for rubbing a contaminated or dirty solid surface, it should preferably be not only resistant but also suitable for catching dirt. This is why said wipe is in a woven, non-woven, knitted material or in a composite film, preferably made in polyethersulfone (PES), polypropylene (PP), polyamide (PA), viscose, rayon fibers, or fibers of other derivatives of cellulose.

Because of its structure, the wipe is cellular and may catch dirt present on said contaminated surface, such as dust, pollen, insects, earth, tar or further all deposits due to pollution.

Generally, an impregnation rate of said cleaning and polishing composition expressed as the mass of said composition per wipe unit mass located between 0.1 g/g and 10 g/g is sufficient.

Another object of the present invention relates to the method for making said wipe, as described above.

This method comprises at least the steps of:
a) preparing a multiphase composition which does not appear as an emulsion as described above,
b) continuously stirring said composition so as to obtain a temporarily homogeneous mixture,
c) impregnating up to a predetermined rate said wipe with the obtained homogeneous mixture, impregnation being accomplished so as to distribute said composition homogeneously in said wipe so that each wipe contains the suitable dose of each of the constituents of said composition,
d) vertically packaging said either impregnated wipe or not in a sealed package compatible with said composition,

steps c) and d) may be performed in any order,
e) leaving the constituents to separate so that they form strata or layers in said wipe depending on their respective density.

It is actually important that the composition which is <<multiphase at rest>> according to the present invention should be homogeneous for the time being so that each constituent of said composition not only impregnates with the same amount, but also with a suitable dose, the wipes in the package.

In a first embodiment, the impregnation step may be performed before packaging the wipe in a sealed package.

For example, the wipes are continuously positioned on a conveyor belt and the cleaning and polishing composition obtained in step b) above is poured on said wipes so as to deposit a sufficient amount of said homogenous mixture for the time being. Next, said impregnated wipes are packaged, generally as a roll positioned vertically in an adequate packer.

In a second embodiment, the impregnation step may be performed after packaging the wipes. The non-impregnated wipes are positioned in an adequate packer, and then the mixture obtained in step b) is injected in order to impregnate the wipes.

Whichever the embodiment, the package compatible with the composition obtained in step a) or b) is preferably of the heat-sealed type.

Further, the wipes are preferably pre-cut out in order to facilitate their use and packaged as a roll positioned vertically so that each wipe may contain the different layers of the products listed above forming said cleaning and polishing composition which is <<multiphase at rest>>.

The particularly suitable packaging or packer may correspond to a bucket, in which wipes of large sizes may be inserted (<<maxi-wipes>>). This packaging has a most particular advantage for applications in the field of industry.

The use of a wipe by a user who wishes to clean his/her motor vehicle will now be described below:
first of all, the user will take out for example a pre-cut wipe out of its package, such as a bucket, as indicated above,
next, he/she will rub the contaminated surface to be treated, here the outer body of a car;

during this rubbing, the different constituents of the cleaning and polishing composition which is <<multiphase at rest>> will again mix so as to reform a substantially homogenous mixture on the surface to be cleaned. From then on, it will be easy for the user to remove the most embedded deposits on said surface,
finally, once the surface to be treated is cleaned, it will be sufficient for the user to wipe said surface with a microfiber fabric, for example a micro-fiber fabric comprising 80% polyester and 20% polyamide.
the resulting surface will be cleaned, traceless, shiny and with a new aspect.

Examples of cleaning compositions which may impregnate a wipe are illustrated in the following Table I:

| Compositions | 1 | 2 | 3 | 4 | 5 | 6 | 7 |
|---|---|---|---|---|---|---|---|
| Ethoxylated C₈ | 50 | — | — | — | — | — | — |
| linear fatty | | | | | | | |
| alcohol with 5 OE | | | | | | | |
| Ethoxylated C₁₂/₁₅ | — | 35 | — | — | — | — | 10 |
| linear fatty | | | | | | | |
| alcohol with 30 | | | | | | | |
| moles of OE | | | | | | | |
| Glycerol cocoate 5 OE | — | — | 15 | — | — | — | — |
| Glucosamide C₁₆/₁₈ | — | — | | 10 | | | |
| C₁₂/C₁₈ | — | — | — | — | 25 | — | — |
| amidopropylbetaine | | | | | | | |
| C₁₂/C₁₈ | — | — | — | — | — | 5 | 5 |
| alkyldimethylbetaine | | | | | | | |
| Shine agent | 20 | 5 | 30 | 40 | 15 | 60 | 50 |
| Cleaning agent | 10 | 20 | 15 | 2 | 5 | 30 | 30 |
| Preservative | 0.5 | 0.5 | 0.5 | 0.5 | 0.5 | 0.5 | 0.5 |
| Other | 1 | 1 | 1 | 1 | 1 | 1 | 1 |
| Water | 18.5 | 38.5 | 38.5 | 46.5 | 53.5 | 3.5 | 3.5 |
| | 100 | 100 | 100 | 100 | 100 | 100 | 100 |

Shine agent: Fat of mineral, synthetic, vegetable and/or animal origin or mixtures thereof such as vaseline oil, paraffinic oils, polyalkylsiloxanes, polybutenes, rapseed oil, etc.
Cleaning agent: chlorinated solvents such as methylene chloride, aromatic solvents such as toluene, Ketone derivatives, such as acetone, methylethylketone, Alcohols such as ethanol, isopropanol, butanol, hydrocarbon derivatives such as heavy and light naptha derivatives
Preservative: sodium benzoate, benzylic alcohol, 1,2-benzisothiazoline-3-one,
Others: coloring agents, perfumes.

1. A wipe intended for cleaning and polishing contaminated surfaces, such as the outer body of a car, said wipe comprises a support impregnated with a cleaning and polishing composition which is not in the form of an emulsion, characterized in that said composition comprises at least one agent for suspending organic and/or inorganic materials (a), at least one cleaning agent (b) and at least one shine agent(c) and possibly a preservative agent (d), said aforementioned constituents being distinct from each other and non-miscible, so as to form a multiphase composition at rest.

2. The wipe according to claim 1, characterized in that the agent for suspending organic and/or inorganic materials (a) is selected from: an agent for suspending organic materials, such as an aqueous solvent like water, an alcoholic aqueous solution, an acid aqueous solution, a basic aqueous solution, a cationic surfactant, a non-ionic surfactant, an anionic surfactant, an amphoteric surfactant, an emulsifying agent or mixtures thereof.

3. The wipe according to claim 1, characterized in that the cleaning agent (b) is selected from solvents with a KBI, a Kauri Butanol Index, comprised between 25 and 300, such as a chlorinated, oxygenated, aromatic organic solvent, a non-polar solvent such as dearomatized and non-dearomatized hydrocarbons, linear paraffins, cycloparaffins, isoparaffins, aromatics, deoxidizing agents or mixtures thereof.

4. The wipe according to claim 1, characterized in that the shine agent(c) is selected from mineral oils, synthetic oils or mixtures thereof.

5. The wipe according to claim 1, characterized in that said composition comprises preservative agents (d) of the fungicide type or of the anti-oxidant type, so as to avoid putrefaction of said composition during its storage.

6. The wipe according to claim 1, characterized in that said composition comprises by weight, 1% to 80%, preferably 60% to 80% of said agent for suspending organic and/or mineral materials (a), 1% to 80%, preferably 10% to 30% of said cleaning agent (b), 0.1% to 60%, preferably from 0.1% to 40% of said shine agent(c) and possibly 0.01% to 80%, preferably from 0.01% to 10% of said preservative agent (d), based on the total weight of said composition.

7. The wipe according to claim 1, wherein said cleaning composition during the storage of the wipe in the vertical position, forms layers depending on the density of the different constituents of said composition.

8. The wipe according to claim 1, characterized in that said support of said wipe is a woven, non-woven, knitted, material or a composite film, so as to be resistant during the cleaning and polishing step.

9. The wipe according to claim 1, characterized in that the impregnation rate of the unstable cleaning and polishing composition expressed as the mass of said composition per wipe unit mass, is comprised between 0.1 g/g and 10 g/g.

10. A method for making said wipe according to claim 1, characterized in that the method comprises at least the steps of:
a) preparing a multiphase for cleaning and polishing composition which does not appear as an emulsion,
b) continuously stirring said composition so as to obtain a temporarily homogenous mixture,
c) impregnating up to a predetermined rate said wipe with the obtained homogenous mixture, impregnation being accomplished so as to distribute said composition homogenously in said wipe so that each wipe contains the suitable dose of each of the constituents of said composition,
d) vertically packaging said either impregnated wipe or not in a sealed package compatible with said composition, steps c) and d) may be performed in any order,
e) leaving the constituents to separate, so that they form strata or layers in said wipe depending on their respective density.
